(19) United States
(12) Patent Application Publication
(10) Pub. No.: US 2011/0132077 A1
(43) Pub. Date: Jun. 9, 2011

(54) MULTI-WAVELENGTH LIGHT SOURCE

(75) Inventors: Kevin P. Killeen, Loveland, CO (US); Karsten Kraiczek, Waldbronn (DE); Hubert Kuderer, Waldbronn (DE)

(73) Assignee: Agilent Technologies, Inc., Sant Clara, CA (US)

(21) Appl. No.: 12/737,693

(22) PCT Filed: Jul. 22, 2009
(86) PCT No.: PCT/EP2009/059401

§ 371 Date: Feb. 4, 2011

Related U.S. Application Data
(62) Division of application No. 61/086,950, filed on Aug. 7, 2008.

(51) Int. Cl. G01N 30/00; G01N 30/74; F21V 11/00

(52) U.S. Cl. 73/61.56; 73/61.52; 73/61.58; 362/235

(57) ABSTRACT

A fluid separation system (10) for separating compounds of a sample fluid in a mobile phase comprises a detector (50) adapted to detect separated compounds by providing an optical stimulus signal to the sample fluid and receiving a response signal to the optical stimulus signal. The detector (50) comprises a light source (100) adapted to provide an output light beam (230) as the optical stimulus signal. The light source (100) comprises a plurality of light emitting elements (200, 200A, 200Z) each adapted to emit a light beam (210, 210A1, 210A2, 210Z1, 210Z2) having a respective wavelength, and a diffracting element (220). The plurality of light emitting elements (200, 200A, 200Z) are arranged that emitted light beams (210, 210A1, 210A2, 210Z1, 210Z2) impinging, on the diffracting element (220) are diffracted by the diffracting element (220) to form the output light beam (230).

### BACKGROUND ART

The present invention relates to a multi-wavelength source in particular in a high performance liquid chromatography application.

In high performance liquid chromatography (HPLC, see e.g. htt://en.wikipedia.org/wiki/HPLC), a liquid has to be provided usually at a very controlled flow rate (e. g. in the range of microliters to milliliters per minute) and at high pressure (typically 200-1000 bar and beyond up to currently 2000 bar; at which compressibility of the liquid becomes noticeable). Piston or plunger pumps typically comprise one or more pistons arranged to perform reciprocal movements in a corresponding pump working chamber, thereby compressing the liquid within the pump working chamber(s). In fluid dynamics and hydrometry, the volumetric flow rate (referred to herein as flow rate) is the volume of fluid which passes through a given surface per unit time, usually measured at the point of detection.

Detectors for HPLC applications are described, e.g., in the documents “Agilent 1200 Series Diode Array and Multiple Wavelength Detectors User Manual”, Publication Numbers: G1315-90006 or G1315-90012, which documents can be retrieved via http://www.chem.agilent.com/scripts/LiteratureResults.asp. On page 13 (in both documents), an optical system of a detector is depicted. Illumination source is a combination of a deuterium-arc-discharge lamp (e.g. Agilent Part No. 5181-1530) for the ultraviolet (UV) wavelength range and a tungsten lamp for the visible (VIS) and short-wave near-infrared (SWNIR) wavelength range. An image of the filament of the tungsten lamp is focused on a discharge aperture of the deuterium lamp by means of a rear-access lamp design (Shine-Through) which allows both light sources to be optically combined and share a common axis to the source lens. An achromat (source lens) forms a single, focused beam of light through a flow cell. In a spectrograph, light is being dispersed onto a photodiode array by a holographic grating. This allows simultaneous access to all wavelength information.

Further details about deuterium lamps can also be found in U.S. Pat. No. 4,611,143 A, U.S. Pat. No. 7,359,049 B2, or with respect to Shine-Through Lamps in DE 19920579 A1 or WO 2008/025523 A1.

### DISCLOSURE

It is an object of the invention to provide an improved multi-wavelength source in particular for HPLC applications. The object is solved by the independent claim(s). Further embodiments are shown by the dependent claim(s).

According to the present invention, a fluid separation system is provided for separating compounds of a sample fluid (introduced) in a mobile phase. The fluid separation system has a detector adapted to detect separated compounds by providing an optical stimulus signal to the sample fluid and receiving a response signal (as a signal in response to the optical stimulus signal). The detector comprises a light source to provide an output light beam which either already is the optical stimulus signal or of which the optical stimulus signal can be derived from. The light source comprises a plurality of light emitting elements and a diffracting element. Each of the light emitting elements is adapted to emit (when the light emitting element is operative, e.g. switched on) a light beam having a respective wavelength. The light emitting elements are arranged so that light beams emitted therefrom are impinging on the diffracting element in a respective angle dependent on the respective wavelength of the respective emitted light beam. The diffracting element diffracts the thus impinging light beams into the output light beam.

The fluid separation system according to the present invention thus allows combining with or even replacing conventional multi-wavelength sources used in HPLC, in particular the aforementioned deuterium lamps, which have been regarded (already for some while) as limiting factor in the sample compounds detection scheme of such fluid separation systems. Thus, certain types of light sources might be “emulated”, so that (dependent on the setup of the light emitting elements) different types of lamps can be “simulated” without requiring to change the light source of the fluid separation system. For example, variable wavelengths detectors (VWD) or multiple wavelengths detectors (MWD) can be emulated by the same detector without requiring to change the light source.

The light source of the present invention allows combining different wavelength sources and thus designing and customizing the light source according to different requirements. For example, the light source might use only a subset of its light emitting elements for a certain application dependent on the specific requirements of such application. Further, by adequately designing and/or adjusting the light emitting elements, certain profiles (e.g. in the sense of optical power provided at a certain wavelength) can be achieved. For example, if all applied light emitting elements emit at a defined (e.g. the same) power level, the output light beam provided from the diffracting element will usually show (dependent in particular on the specific properties of the light emitting elements and/or the diffracting element) a spectrum with equalized intensities and/or output power of the respective wavelength components. It is clear that any required profile may thus be achieved by adequately selecting and arranging the plurality of light emitting elements.

As another advantage, the light spot (e.g. the illuminated area) of the output light beam can be designed to be relatively small (e.g. in contrast to the conventional deuterium lamps), mainly dependent on the properties of the light emitting elements (e.g. size) and/or the diffracting elements. Thus, a high power density and small light spot area can be achieved resulting in improved properties of and for the sample compounds detection.

One embodiment further comprises a control unit coupled to the light source and which is adapted to control operation of the light source and/or one or more of the light emitting elements. With such control unit, the specific properties of the output light beam can (further) be designed, selected and/or controlled. Thus, the output light beam can be customized to a specific application e.g. in respect to its wavelength components (also referred to as spectral components) and intensity profile.

In one embodiment, the control unit controls a number of light emitting elements to be concurrently emitting light beams, e.g. by using a switching unit selectively switching on or off one or more of the light emitting elements.

In case the light emitting elements are individually addressable and can be switched on and off individually, stray light can be reduced and only such light emitting elements required in the desired output light beam profile need to be selected and operated.

In one embodiment, the control unit controls the respective wavelength (or wavelength profile) of one or more of the light emitting elements. This allows adjusting or providing a tuning of the wavelength profile and setup of the output light beam. This can be done e.g. by controlling at least one of temperature, current, voltage of one or more of the light emitting elements, or by switching on and off the corresponding light emitting elements.

In one embodiment, the control unit controls modulation and/or multiplexing of one ore more of the emitted light beams. Such embodiment allows using a type of receiver, which per se cannot detect/distinguish individual wavelength components of the received response signal. Accordingly, such receiver (such as an opto-electronic photodiode) might only detect the resulting intensity of the response signal. When modulating and/or multiplexing the emitted light beams it becomes possible to trace individual wavelength components in the response signal without requiring a wavelength dependent or selective receiver.

In one embodiment, the control unit provides at least one of time multiplexing, frequency multiplexing, code multiplexing, amplitude modulation, and frequency modulation of one or more of the emitted light beams. The general principles of multiplexing and modulation are readily known and described e.g. under http://en.wikipedia.org/wiki/Multiplexing or http://en.wikipedia.org/wiki/Modulation together with their subsections. Code multiplexing, which has been found particularly useful, is described e.g. under http://en.wikipedia.org/wiki/Code-division multiple access.

In one embodiment, the control unit controls intensity of at least one of the emitted light element and/or their emitted beam(s), thus allowing an active control of the profile of the output light beam with respect to its intensity components.

One or more of the emitted light beams might be equalized in intensity, thus allowing to provide the stimulus signal with a defined intensity profile (for example with a substantially flat intensity profile), at least in a given spectral range or sub-range, so that all stimulus components of the stimulus signal are at a defined (e.g. the same) intensity level. This allows reducing sensitivity on spectral variations, on side of the stimulus as well as the response signal, which might otherwise be erroneously interpreted a signal. As an example, a conventional deuterium lamp has discrete intensity peaks at certain wavelengths. Any shift or variation in wavelength in the range of such peaks will cause a significant variation in the signal, which however is not caused by the sample fluid and thus a wanted signal, but an erroneous signal leading to measurement inaccuracies. As a further advantage of equalized spectral intensities, electronic units of the control unit can operate in the same or almost same amplification range.

One or more of the light emitting elements might be embodied as a light emitting diode (LED), which can be for example a semiconductor LED or an organic LED (oLED), an array of LEDs, a plasma source such as a micro-plasma, a laser diode, a discharge lamp such as a micro discharge lamp, etc. It is clear that the light source can comprise different types of light emitting elements thus allowing to provide the desired wavelength profile for the output beam.

The diffraction element might be embodied by a diffraction grating, which might be for example a plain diffraction grating or a spherical diffraction grating (which exhibits a focusing property resulting from its spherical shape). Alternatively, a prism might be used. One or more lenses and/or mirror might also be used for focusing, defocusing and/or redirecting beams.

In one embodiment, the light source also allows receiving the response signal and thus also serves as the receiver. In that case, the diffracting element diffracts the received response beam in an angle dependent on the wavelength of the respective wavelength components of the response beam. The light emitting elements, or at least a subset thereof, are also adapted to sense the respective wavelength components diffracted from the diffracting element.

In addition or in case the light emitting elements are not adapted to also sense light, the response signal might be (spatially) offset with respect to the output beam, so that the diffracted components of the response signal are also (spatially) offset with respect to the beams emitted from the light emitting elements. This allows providing one or more light detecting elements (e.g. a photodiode array) spatially separated from the light emitting elements (i.e. in a different spatial position). Spatially offsetting can mean having the light emitting elements in one location, such as a first array, and light receiving elements in another location, such as a second array. Spatially offsetting can also mean locating a respective light emitting element and a respective and corresponding (e.g. in the sense of the two elements are to either emit or receive at the same wavelength) light receiving element spatially close together, e.g. as neighboring or abutting elements, thus forming a pair of emitting and receiving elements. Plural of such pairs can then be combined or arranged to an array.

Offsetting the response signal can be achieved e.g. by using a back-directing element (such as any kind of back-reflecting element, a mirror, dihedral element, etc.) which returns the received beam in opposite direction and spatially offset. Dependent on the setup, the returning beam might be directed again through the sample fluid or guided in a different path.

In embodiments, the control unit uses at least one beam from the diffracting element for controlling operation of the light source. Such beam might be either diffracted or reflected (i.e. zero order) from the diffracting element. This also allows monitoring the output beam in particular with respect to its spectral and intensity profile as well as optical power (intensity) output stability. An in situ monitoring and control can thus be achieved allowing to directly monitoring the output beam without influencing the output beam, as such beam(s) used for monitoring are not coupled off from the output beam but are “automatically” provided by the diffracting element.

In one embodiment, an input beam is used for coupling light into the output beam as zero order, which in-coupled light is independent on the light emitting elements. The input beam represents a beam, which is reflected by the diffracting element “into the output beam” as zero order, i.e. in the same angle (absolute value) as the output beam leaves the diffraction element. This allows to couple in certain wavelength component(s), polychromatic wavelength spectra, light types (e.g. such as light from a conventional deuterium lamp), etc. into the output beam, independent on the wavelength of such in-coupled light. Also, certain wavelength component(s) of the light emitting element(s) can thus be added and accordingly be amplified in the output beam.

While the invention is applicable over substantially the entire optical wavelength range, e.g. from deep UV to infrared, certain wavelength ranges have been shown in particular useful in fluid separation, such as from deep UV to near infrared, e.g. 200 nm-1000 nm, or 200 nm-400 nm (and up to 600 nm).

Further details about detectors as used in HPLC are readily available e.g. in the Internet document “The Diode Array Detector”, see http://www.chromatography-online.org/HPLC-Detectors/UV/Diode-Array/rs49.html; the book “Spectrochemical Analysis”, James D. Ingle, 1988, ISBN 0-13-826876-2; or the booklet “Applications of diode-array detection in HPLC”, L. Huber, 1989, Hewlett-Packard Co. Publication Number 12-5953-2330.

Embodiments of the present invention might be embodied based on most conventionally available HPLC systems, such as the Agilent 1200 Series Rapid Resolution LC system or the Agilent 1100 HPLC series (both provided by the applicant Agilent Technologies—see www.agilent.com—which shall be incorporated herein by reference).

One embodiment comprises a pumping apparatus comprising a piston for reciprocation in a pump working chamber to compress liquid in the pump working chamber to a high pressure at which compressibility of the liquid becomes noticeable.

One embodiment comprises two pumping apparatuses coupled either in a serial or parallel manner. In the serial manner, as disclosed in EP 309596 A1, an outlet of the first pumping apparatus is coupled to an inlet of the second pumping apparatus, and an outlet of the second pumping apparatus provides an outlet of the pump. In the parallel manner, an inlet of the first pumping apparatus is coupled to an inlet of the second pumping apparatus, and an outlet of the first pumping apparatus is coupled to an outlet of the second pumping apparatus, thus providing an outlet of the pump. In either case, a liquid outlet of the first pumping apparatus is phase shifted, preferably essentially 180 degrees, with respect to a liquid outlet of the second pumping apparatus, so that only one pumping apparatus is supplying into the system while the other is intaking liquid (e.g. from the supply), thus allowing to provide a continuous flow at the output. However, it is clear that also both pumping apparatuses might be operated in parallel (i.e. concurrently), at least during certain transitional phases e.g. to provide a smooth(er) transition of the pumping cycles between the pumping apparatuses. The phase shifting might be varied in order to compensate pulsation in the flow of liquid as resulting from the compressibility of the liquid. It is also known to use three piston pumps having about 120 degrees phase shift.

The separating device preferably comprises a chromatographic column (see e.g. http://en.wikipedia.org/wiki/Column chromatography) providing the stationary phase. The column might be a glass or steel tube (e.g. with a diameter from 50 um to 5 mm and a length of 1 cm to 1 m) or a microfluidic column (as disclosed e.g. in EP 1577012 or the Agilent 1200 Series HPLC-Chip/MS System provided by the applicant Agilent Technologies, see e.g. http://www.chem.agilent.com/Scripts/PDS.asp?IPage=38308). For example, a slurry can be prepared with a powder of the stationary phase and then poured and pressed into the column. The individual components are retained by the stationary phase differently and separate from each other while they are propagating at different speeds through the column with the eluent. At the end of the column they elute one at a time. During the entire chromatography process the eluent might be also collected in a series of fractions. The stationary phase or adsorbent in column chromatography usually is a solid material. The most common stationary phase for column chromatography is silica gel, followed by alumina. Cellulose powder has often been used in the past. Also possible are ion exchange chromatography, reversed-phase chromatography (RP), affinity chromatography or expanded bed adsorption (EBA). The stationary phases are usually finely ground powders or gels and/or are microporous for an increased surface, though in EBA a fluidized bed is used.

The mobile phase or eluent is either a pure solvent or a mixture of different solvents. It can be chosen e.g. to minimize the retention of the compounds of interest and/or the amount of mobile phase to run the chromatography. The mobile phase can also been chosen so that the different compounds can be separated effectively. The mobile phase might comprise an organic solvent like e.g. methanol or acetonitrile, often diluted with water. For gradient operation water and organic is delivered in separate bottles, from which the gradient pump delivers a programmed blend to the system. Other commonly used solvents may be isopropanol, THF, hexane, ethanol and/or any combination thereof or any combination of these with aforementioned solvents.

The sample fluid might comprise any type of process liquid, natural sample like juice, body fluids like plasma or it may be the result of a reaction like from a fermentation broth.

The pressure in the mobile phase might range from 20 to 2000 bar, and in particular 100 to 1500 bar, and more particular 500 to 1200 bar.

The HPLC system might further comprise a sampling unit for introducing the sample fluid into the mobile phase stream, a detector for detecting separated compounds of the sample fluid, a fractionating unit for outputting separated compounds of the sample fluid, or any combination thereof. Further details of HPLC system are disclosed with respect to the Agilent 1200 Series Rapid Resolution LC system or the Agilent 1100 HPLC series, both provided by the applicant Agilent Technologies, under www.agilent.com which shall be in cooperated herein by reference.

Embodiments of the invention can be partly or entirely embodied or supported by one or more suitable software programs, which can be stored on or otherwise provided by any kind of data carrier, and which might be executed in or by any suitable data processing unit. Software programs or routines can be preferably applied in or by the control unit.

### BRIEF DESCRIPTION OF DRAWINGS

Other objects and many of the attendant advantages of embodiments of the present invention will be readily appreciated and become better understood by reference to the following more detailed description of embodiments in connection with the accompanied drawing(s). Features that are substantially or functionally equal or similar will be referred to by the same reference sign(s).

FIG. 1 shows a liquid separation system 10, in accordance with embodiments of the present invention, e.g. used in high performance liquid chromatography (HPLC).

FIG. 2 illustrates the principal of operation of a typical embodiment of the detector 50.

FIG. 3 shows an example of an embodiment of the light source 100 according to the present invention.

FIG. 4 illustrates an embodiment providing a time multiplexing of the light source 100.

FIG. 5 shows an embodiment using frequency multiplexing.

FIGS. 6A and 6B illustrate embodiments, wherein the emitted light beams 210 are coded each with a characteristic identification portion.

FIG. 7 shows an embodiment, wherein the receiver 120 is embodied similarly to the light source 100.

FIG. 8 shows an embodiment of the detector 50, wherein the light source 100 is used also for receiving the response signal.

FIG. 9 shows an embodiment, wherein the control unit 70 uses at least one beam from the diffracting element 220 for controlling operation of the light source 100.

FIG. 10 shows an embodiment, wherein an input beam 950 is used for coupling light into the output beam 230 as zero order.

FIGS. 11 and 12 show embodiments of the light source 100 providing plural output light beams.

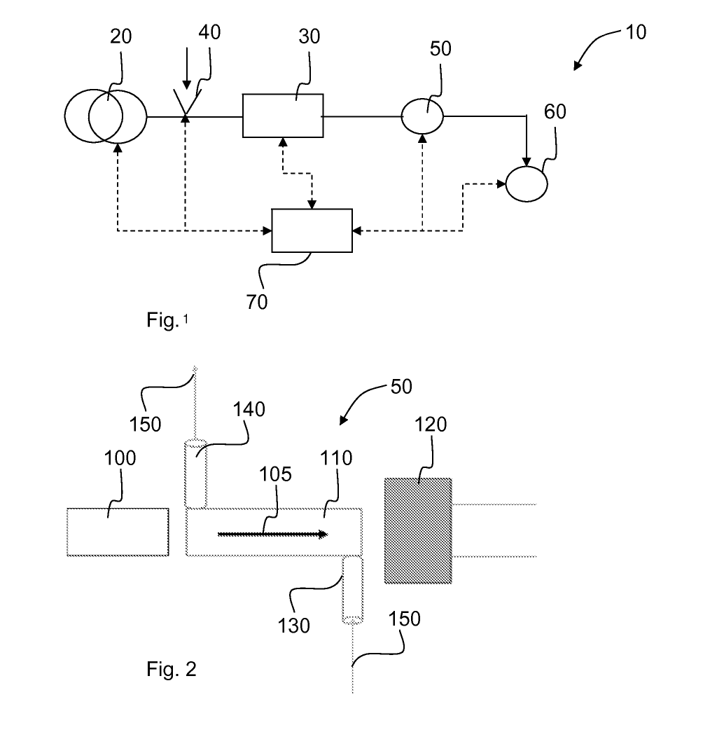

Referring now in greater detail to the drawings, FIG. 1 depicts a general schematic of a liquid separation system 10. A pump 20—as a mobile phase drive—drives a mobile phase through a separating device 30 (such as a chromatographic column) comprising a stationary phase. A sampling unit 40 can be provided between the pump 20 and the separating device 30 in order to introduce a sample fluid to the mobile phase. The stationary phase of the separating device 30 is adapted for separating compounds of the sample liquid. A detector 50 is provided for detecting separated compounds of the sample fluid. A fractionating unit 60 can be provided for outputting separated compounds of sample fluid.

A data processing unit 70, which can be a conventional PC or workstation, might be coupled (as indicated by the dotted arrows) to one or more of the devices in the liquid separation system 10 in order to receive information and/or control operation. For example, the data processing unit 70 might control operation of the pump 20 (e.g. setting control parameters) and receive therefrom information regarding the actual working conditions (such as output pressure, flow rate, etc. at an outlet of the pump). The data processing unit 70 might also control operation of the sampling unit (e.g. controlling sample injection or synchronization sample injection with operating conditions of the pump 20). The separating device 30 might also be controlled by the data processing unit 70 (e.g. selecting a specific flow path or column, setting operation temperature, etc.), and send—in return—information (e.g. operating conditions) to the data processing unit 70. Accordingly, the detector 50 might be controlled by the data processing unit 70 (e.g. with respect to spectral or wavelength settings, setting time constants, start/stop data acquisition), and send information (e.g. about the detected sample compounds) to the data processing unit 70. The data processing unit 70 might also control operation of the fractionating unit 60 (e.g. in conjunction with data received from the detector 50) and provides data back.

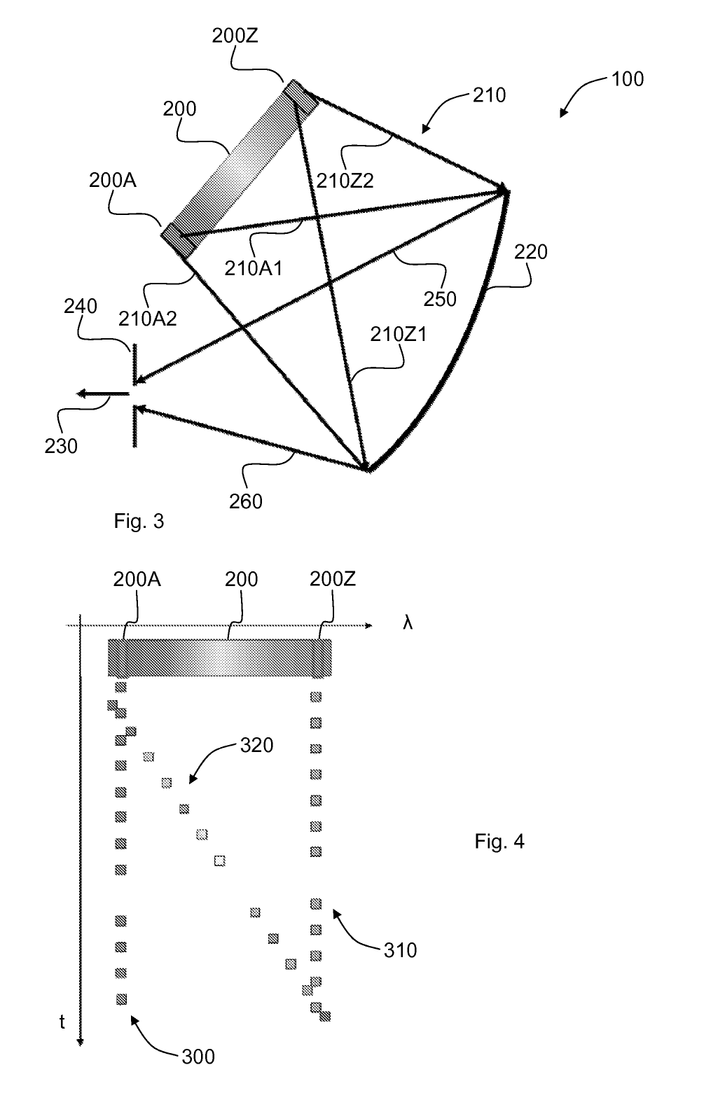

In FIG. 2, the light source 100 emits an optical stimulus signal (indicated as arrow 105) into a flow cell 110 conducting the mobile phase (which might comprise also the sample fluid or respective separated compounds thereof). A receiver 120 receives a response signal in response to the optical stimulus signal. In ideal case (i.e. without any unwanted coupling in and off and/or any influence of any disturbance source), the response signal represents the stimulus signal after passing the fluid into the flow cell 110. However, stray light, out-coupled portions of the stimulus signal, etc. might affect the received response signal and e.g. decrease the signal to noise ratio. Further in FIG. 2, a conduit 130 at an input of the flow cell 110 and a conduit 140 at an output of the flow cell 110 are depicted to illustrate the principle setup of a typical flow cell arrangement in HPLC applications. The flow direction of the mobile phase is indicated by arrows 150.

The detector 50 can be operated to detect absorbance of the stimulus signal by the fluid (i.e. the mobile phase including or without the sample fluid) in the flow cell 110. Variations in the absorbance indicate variations in the fluid and allow drawing back on the properties of separated compounds present in the flow cell 110. As the mobile phase together with the sample fluid is continuously moved through the flow cell 110, the receiver 120 receives a signal varying over time (usually called chromatogram). Details of such absorption cells are readily known in the art and need not be laid out here in detail. Examples can be found e.g. in the aforementioned documents such as “Agilent 1200 Series Diode Array and Multiple Wavelength Detectors User Manual”, EP1522849 A1, EP762119 A1.

Another concept of detection also well known in the art is fluorescence detection. The stimulus signal stimulates a fluorescence signal from the fluid which is then detected by the receiver 120, as also explained in detail in the aforementioned book “Spectrochemical Analysis” by James D. Ingle. Other types of detection, also illustrated in that book, are refractive index and light scattering measurement. It is clear that any type of suitable detection can be used accordingly for the purpose(s) of the present invention.

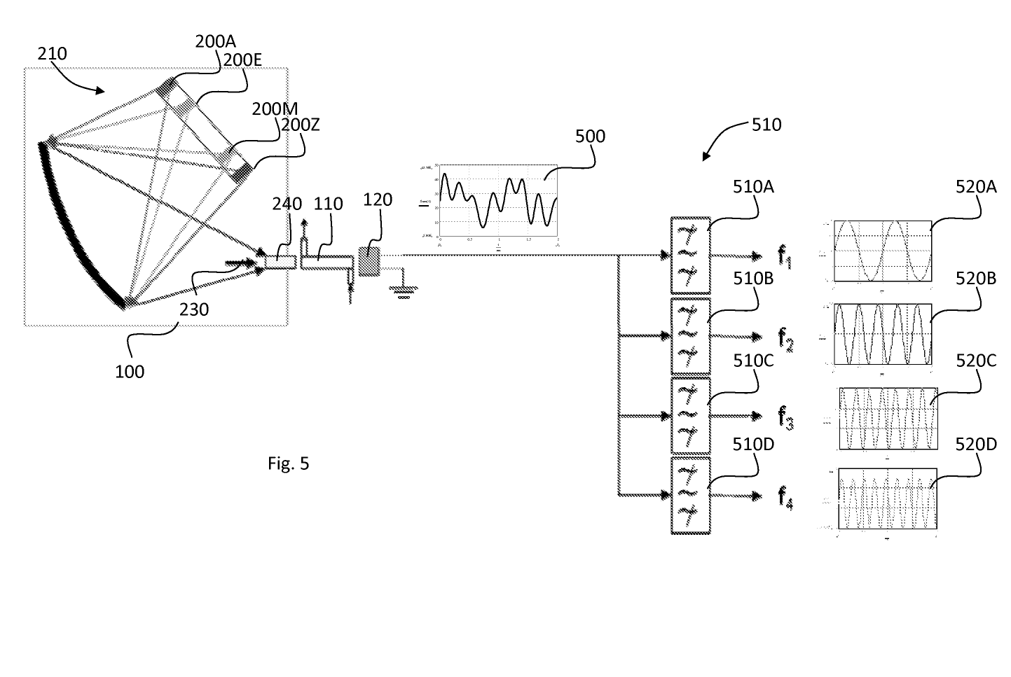

FIG. 3 shows an example of an embodiment of the light source 100 according to the present invention. The light source 100 comprises a plurality of light emitting elements 200. In the embodiment of FIG. 3, the plurality of light emitting elements 200 are embodied by an array of light emitting diodes (LED). For the sake of simplicity, only the two outer LEDs shall be indicated individually in FIG. 3 as light emitting elements 200A and 200Z. Each light emitting element 200A, . . . , 200Z is adapted to emit a light beam 210. In the example of FIG. 3, the light beam 210 from light element 200A is indicated by light beams 210A1 and 210A2 spanning up the light beam 210 of light emitting element 200A hitting a diffracting element 220, which shall be embodied in this example as a grating. Accordingly, the light beam 210 from light emitting element 200Z is indicated by the two light beams 210Z1 and 210Z2 covering the diffracting element 220.

Due to the diffracting property of the diffracting element 220, light impinging on the diffracting element 220 is diffracted dependent on the wavelength of the impinging light beam. When arranging the light emitting elements 200 in respect to their emitted wavelength in a certain angle with respect to the diffracting element 220, an output light beam 230 can be generated comprising wavelength components of the emitted light beams 210. The technique of combining spectral components using a diffracting element is also described in U.S. Pat. No. 3,472,594 or U.S. Pat. No. 7,248,359 B2, which teaching shall be incorporated herein by reference.

An optical arrangement 240, such as one or more of an aperture hole, a slit, an optical fiber, and a fiber piece, maybe combined with a lens, a mirror, etc., might further be provided in order to guide the output beam 230 and/or to reduce unwanted spectral components or other light beams propagating into the output beam 230.

For the sake of completeness, beams 250 and 260 shall represent the outer portion of a divergent output beam 230. It is clear that in case of a plain diffracting element 220 (e.g. a plain grating)—in contrast to the spherically formed diffracting element 220 as shown in the figures—the output beam 230 could be a parallel beam, in particular in case the light emitting elements 200 emit parallel beams 210 (in contrast to the divergent beams as shown in the figures).

In case the light emitting elements 200A-200Z are arranged adequately so that the diffracting element 220 can map each of the emitted light beams 210 into the output light beam 230, the light source 100 can thus be operated in order to provide the output beam 230 having a spectral composition as defined and designed by the composition and arrangement of the light emitting elements 200. Thus, it becomes possible to generate or design the output light beam 230 with a desired spectral composition or profile. Accordingly, certain spectral compositions or profiles, for example of known and used light sources (such as e.g. the aforementioned deuterium lamp) can be emulated/simulated or even be optimized. However, also entirely new spectral compositions can be derived and e.g. optimized for a certain application. Spectral components might also be equalized in the intensity levels of the spectral components, for example having a flat intensity over wavelength characteristic, which might allow improving measurement accuracy. Due to the wavelength filtering properties of the diffracting element 220, the output light beam 230 can be achieved with increased spectral purity.

In the preferred embodiment as shown in FIG. 3, the light emitting elements 200 are embodied by an array of light emitting elements 200, preferably comprising a plurality of individual LEDs (combined to an array). The spectral composition of the array can be adjusted to the respective requirements. Also, the spatial and geometric arrangement of the individual LEDs in the array 200 can be adjusted to the geometrical and spatial design of the light source 100 and in particular with respect to the specific diffracting properties of the diffracting element 220. It is clear that the properties (in particular the geometrical and spatial design) of the diffracting element 220 can also be adjusted to the requirements and properties (e.g. geometrical and spatial design) of the light emitting elements 200.

The light source 100 not only allows providing the output light beam 230 with a defined polychromatic light composition (e.g. as a substitute for a conventional detector lamp), it is also clear that by individually addressing one or more of the individual light emitting elements 200, e.g. by simply switching on and off, the spectral composition and profile (e.g. the intensity distribution over wavelength) can also be varied e.g. over time, so that certain spectral components might be added or omitted over time, and/or the intensity of one or more wavelength components of the output light beam 230 can be varied.

Alternatively, the light source 100 might also be used—in a single wavelength mode—for outputting monochromatic light as the output light beam 230, e.g. by switching on only one of the light emitting elements 200. Accordingly, the wavelength of such monochromatic output can be varied over time, e.g. by switching from one light emitting element 200 to another, either continuously or with some delay.

Using LEDs either in individual form or as an array allows providing the light source 100 in smaller, more compact, and even lower power consuming form as conventional light sources used in particular in HPLC applications, such as the aforementioned deuterium lamp. Further, using LEDs in contrast to conventional light sources typically renders the light source 100 to be mechanically more robust, and also allows miniaturizing the design of the light source as well as miniaturization and simplifying the overall design of the detector 50. Moreover, entirely new detection schemes can be achieved based on the flexible and controllable spectral composition and intensity profile of the output beam 230.

Light emitting elements not required for a certain wavelength profile of the output light beam 230 can simply be switched off, thus also reducing stray light leading to a better linearity and increased measurement accuracy.

In one embodiment, so called “source wavelength bunching” is applied, which means that the optical bandwidth of the output signal 230 (or at least of one or more wavelength components) is increased in order to increase the signal energy and thus intensity. In other words, the spectral bandwidth of at least one wavelength component of the output signal 230 is increased. As an example, a first LED (as one light emitting element 200) having a central wavelength of 250 nm and spectral bandwidth of 6 nm is applied to generate the output beam 230, thus resulting in a photo current of e.g. 10 nA at the receiver 120. An increased photo current usually means a higher signal to noise ratio, but at the same time the power output the LED is limited. In order to increase the power of the output beam 230, a second LED having a central wavelength close the central wavelength of the first LED is switch on. This can be continued by switching on further LEDs (having a central wavelength close the central wavelength of the first LED), thus effectively increasing the signal to noise ratio. However, it is clear that the source wavelength bunching on the other hand limits the spectral resolution of the measurement and will in particular be limited by the spectral wavelength dependency (e.g. absorption) of the sample fluid or compound to be detected.

The light source 100 can be used in different ways for example dependent on the type of receiver 120 used. For example in case a photo detector is used as receiver 120, such photo detector (e.g. a photo diode) typically measures intensity of the received signal only, but cannot distinguish for different wavelengths. Accordingly, in such case the output of the photo detector 120 represents the integrated power of the optical signal received by the photo detector 120.

The light source 100 might be operated in the sense of a light source typically used in a variable wavelength detector (VWD) providing monochromatic light, for example according to a wavelength setting, which might be varied over time. Light emitting elements 200 which are not needed are simply switched off.

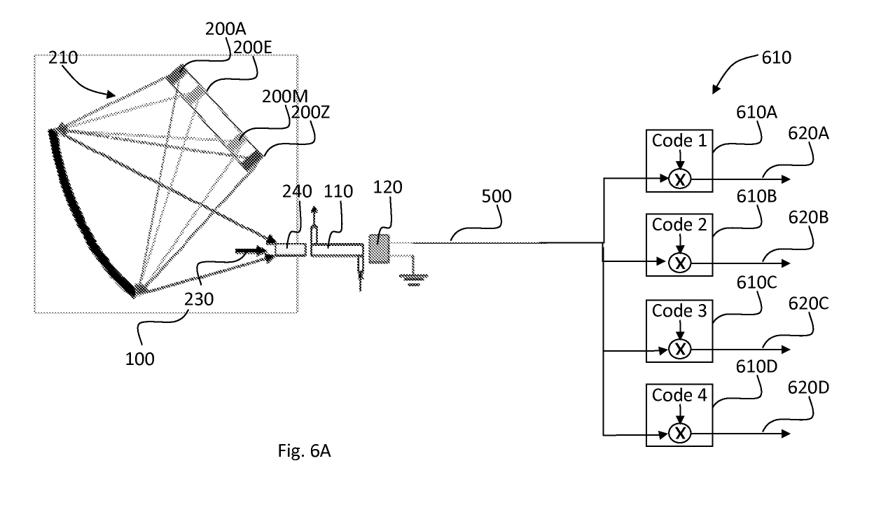

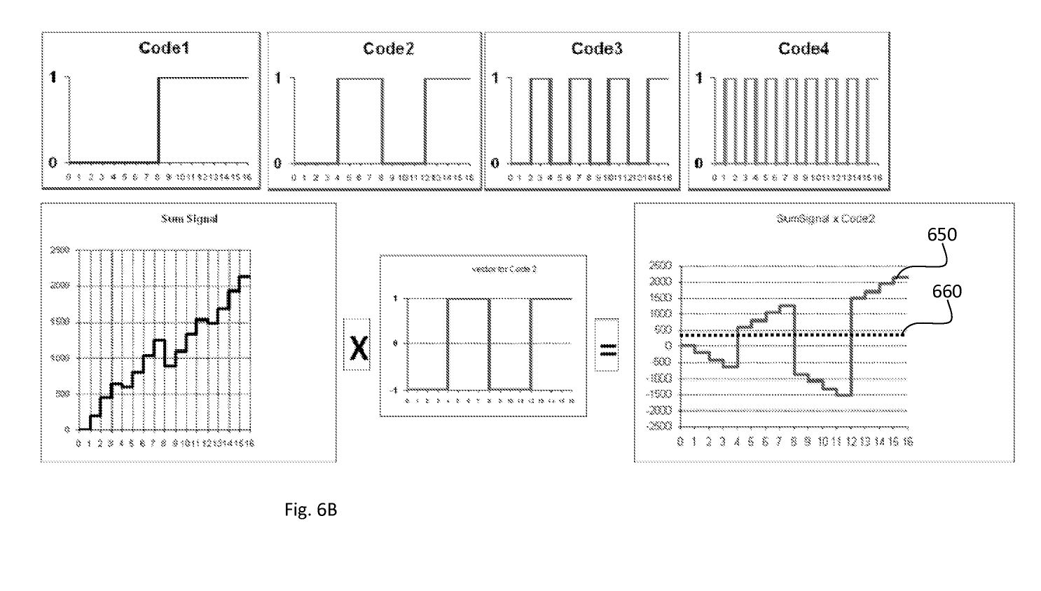

The light source 100 might also be operated in a multi wavelength mode in the sense of a multi wavelength detector (MWD) providing two or more wavelength simultaneously as the output light beam 230. In case a photo detector is used as the receiver 120, the spectral components of the received response signal have to be somehow masked to allow detecting them individually. This can be achieve, for example, by time and/or frequency multiplexing the light emitting elements 200 as illustrated in FIGS. 4 and 5.

FIG. 4 illustrates an embodiment providing a time multiplexing of the light source 100. In a first example, two of the light emitting elements 200 (denoted in the embodiment of FIG. 4 as the two light emitting elements 200A and 200Z) shall be switched on and off alternatively. The resulting signal can be seen in FIG. 4 with the time t depicted on the abscissa, and the wavelength component depicted on the ordinate. Switching light emitting elements 200A on and off leads to a series 300 (i.e. all the rectangular points underneath light emitting elements 200A, illustrating when the light emitting element 200A is switched on). Accordingly, the light emitting element 200Z generates a series 310 (all rectangular points underneath light emitting elements 200Z, illustrating when the light emitting element 200Z is switched on). As the emitted signals (i.e. the rectangular points) of series 300 and 310 are shifted with respect to each other and do not coincide (i.e. only one of the light emitting elements 200A and 200Z emits at a point in time), the photo detector 120 will receive the accordingly shifted response signals and can thus distinguish the response signals for the respective light emitting elements 200A or 200Z.

A diagonal series 320 in FIG. 4 depicts a different example, wherein different light emitting elements 200 are switched on, only one at the time and one after the other. Thus, a wavelength range can be covered, whereby consecutive data points at different wavelengths are generated one after the other. It goes without saying that any profile can be used or generated only dependent on the technical limitation of the setup, e.g. number of different wavelengths, switching speed from one light emitting element to another, transient behavior of the photo detector 120, etc. However, the typical frequency range of about 0.001 Hz to 10 Hz as used in most HPLC applications can be easily met by most currently available LEDs and photodiodes.

FIG. 5 shows an embodiment using frequency multiplexing. As in FIG. 4, the photo detector 120 is used, which cannot distinguish different wavelength components. In this embodiment, plural light emitting elements 200 are emitting at the same time, however each emitted light beam 210 being modulated in frequency. Receiver 120, which in this embodiment shall also be a photo detector, receives the response signal resulting from all emitted light beams 210. The photo detector 120 converts the received optical signal into an electrical signal 500. A couple of filter stages 510 are coupled to the photo detector 120 and receive the converted signal 500. Each filter stage 510A, . . . , 510D is adapted to filter out a respective wavelength component from a respective light emitting element 200 corresponding to the frequency modulation of the emitted light beam 210.

In the example of FIG. 5, light emitting element 200A has been modulated in amplitude with a frequency f₁, light emitting element 200E has been modulated in amplitude by a frequency f₂, light emitting element 200M has been amplitude modulated by a frequency f₃, and light emitting element 200Z has been modulated in amplitude by a frequency f₄. Filter 510A is designed to filter for frequency f₁ (i.e. to output the frequency component f₁), filter 510B filters for frequency f₂, filter 510C filters for frequency f₃, and filter 510D filters for frequency f₄.

In case of no absorbance along the light path from the light source 100 to the photo detector 120, the filtered out components 520A, . . . , 520D will not vary in amplitude as shown in FIG. 5. In other words, the filtered out signals remain unchanged and the calculated absorbance A equals zero, as can be seen from

A=log(1/T)=−log T

with T being the transmission and equaling to the intensity at a time t divided by the intensity at a time zero and also equals the photocurrent at the time t divided by the photocurrent at the time zero. The chromatographic signal remains unchanged.

In case of absorbance occurring in the signal path between the light source 100 and the photo detector 120, the signal components 520A to 520D will change in amplitude according to the wavelength specific absorption coefficients of the sample.

As well known in the art of fluid separation, different spectral absorption characteristics allow drawing back on the respective separated compounds, as some fluid compounds exhibit a variation in absorbance dependent on the wavelength.

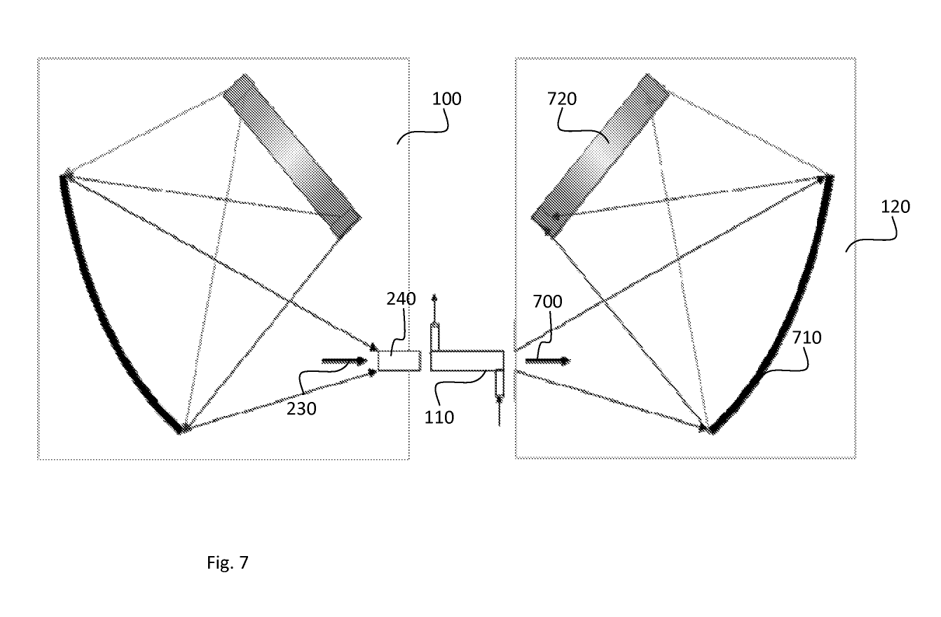

FIGS. 6A and 6B illustrate embodiments, wherein the emitted light beams 210 are coded each with a characteristic identification portion, thus allowing to identify a corresponding signal component in the response signal received by the photo detector 120. This can be achieved e.g. by decoding the response signal preferably by using the same code(s) used for coding the stimulus signal (i.e. the respective emitted lights beams 210).

In the example of FIG. 6A, four light emitting elements 200A, 200E, 200M and 200Z shall concurrently emit respective light beams 210A, 210E, 210M and 210Z, each carrying a characteristic identification portion. Photo detector 120 receives the resulting response signal and converts that into the converted signal 500. The signal 500 is then decoded by a decoder 610 preferably corresponding to the coding scheme provided to the emitted light beams 210. This is indicated in FIG. 6A in that the decoder 610 comprises four correlators 610A, 610B, 610C, 610D, each demodulating the signal 500. Each of the individual light emitting elements 200 (and accordingly their respective wavelength component in the output signal 230) can be associated with an appropriate coding. The decoder 610 is thus enabled to trace the identification portion originating from the coded emitted light beams 210 within the response signal 500.

In the embodiment of FIG. 6A, the emitted beam 210A (indicated by the arrows from the light emitting element 200A) is modulated using a first binary code Code 1. The emitted beam 210E (indicated by the arrows from the light emitting element 200E) is modulated using a second binary code Code 2, the emitted beam 210M (indicated by the arrows from the light emitting element 200M) is modulated using a third binary code Code 3, and the emitted beam 210Z (indicated by the arrows from the light emitting element 200Z) is modulated using a fourth binary code Code 4. Codes 1, 2, 3 and 4 are preferably selected to be orthogonal to each other. Orthogonal codes have a cross-correlation equal to zero; in other words, they do not interfere with each other. It is clear that orthogonal codes will lead to a higher accuracy than codes showing a certain degree of correlation.

FIG. 6B shows an embodiment of the codes Code 1, Code 2, Code 3, and Code 4, all being orthogonal to each other. From this embodiment it becomes clear that coding can simply mean switching the respective emitting elements 200 on and off in a defined sequence and manner. The thus resulting stimulus signal is indicated in FIG. 6B as Sum Signal for an example with the emitting element 200A emitting at an intensity level (amplitude) of 888(relative unit), the emitting element 200E emitting at an intensity level of 600, the emitting element 200M emitting at an intensity level of 444, and the emitting element 200Z emitting at an intensity level of 200.

In FIG. 6A, the response signal leaving the flow cell 110 is then detected at the receiver 120, for example a photo detector, and converted into the electrical domain as the converted signal 500. The converted signal 500 contains coded signals and is coupled to the decoder 610 containing four correlators 610A, 610B, 610C, 610D. Each correlator 610A-610D is demodulating the signal 500 by multiplying signal 500 with the codes Code 1, Code 2, Code 3 and Code 4, respectively. The results of the demodulation is then provided by the decoder 610 at output ports 620A, 620B, 620C, and 620D of the correlators 610A, 610B, 610C, and 610D, respectively.

The lower part of FIG. 6B shows an example of the decoding scheme. Assuming—for the sake of better understanding—that no absorption or other loss occurs in the signal path, so that the receiver 120 receives the stimulus signal and accordingly the converted signal 500 also represents the signal Sum Signal, as depicted in the lower part of FIG. 6B. Multiplying the Sum Signal with a vector (i.e. logical 0 is converted into −1) for a respective one of the codes, and averaging the thus resulting signal will provide the intensity (amplitude) of the respective light emitting element (however multiplied by the duty cycle of the respective code). In the example of the lower part of FIG. 6B, the Sum Signal is multiplied with the calculated vector of Code 2, thus resulting in a signal 650. Averaging the signal 650 over the codes repetition period (i.e. the period until the sequence of the codes Code 1-Code 4 starts repeating again) leads to a value of 300 (indicated as reference numeral 660), which is intensity level of 600 of the emitting element 200E multiplied by the duty cycle of 0.5 of the Code 2. The duty cycle represents the ratio of on-time of the respective light emitting element over the codes repetition period.

In case of absorption occurring in the flow cell 110, the intensity level of the signal received by the receiver 120 is reduced accordingly, and the calculated average signal 660 will represent such reduced signal. In case absorption occurs the same over all emitted wavelengths (i.e. the respective sample compound in the flow cell 110 does not show a wavelength dependency, at least in the wavelength range of the emitted light beams 210), all demodulated signal 620 will show the same relative decrease of the intensity level of the respective light emitting elements 200. In case the respective sample compound in the flow cell 110 shows a wavelength dependency, this will be reflected in the averaged value 660 output by the demodulated signal 620. For example, if the sample compound absorbs 50% of light at the wavelength emitted by the light emitting element 200E, while no absorption occurs at other wavelengths, only the averaged value 660 output by the demodulated signal 620 will show a decrease of 50% (relative the intensity level of the respective light emitting elements 200E).

In case absorption varies over time (as it usually does in chromatography), this will be represented by a variation over time of the average value 660, as the signal averaged over each respective codes repetition period. Each averaged value 660 for a respective codes repetition period may thus represent one data point of the chromatogram.

In order to improve accuracy of the measurement, the codes repetition period should be selected to be smaller, and preferably significantly by about factor 10 and more, than variations in the signal to be measured. Typical peak widths in chromatograms are in the range of 1 s and longer (up to minutes). Accordingly, in order to sample the chromatographic peak with sufficient data points, the codes repetition period is preferably selected corresponding to the number of desired data points. For example for sampling a peak with a peak width of 1 s and with at least 10 data points, the codes repetition period should be 100 ms or smaller. In the example of FIG. 6B, Code 4 has the highest frequency (eight times larger than the codes repetition period), so that the frequency for switching on and off of the respective light emitting element 200Z needs to be 80 Hz. This can, for example, be easily achieved with commercially available LEDs, which allow operation in KHz range and higher.

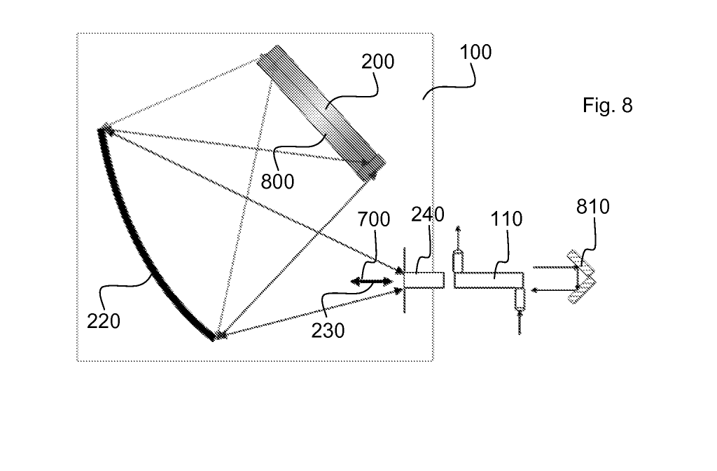

FIG. 7 shows an embodiment, wherein the receiver 120 is embodied similarly to the light source 100. The response signal (indicated by arrow 700) impinges on a second diffracting element 710 diffracting the different spectral components of the response signal 700 in different angles. A photo diode array 720 is arranged to sense the diffracted spectral components received from the diffracting element 710. Such receiver can be embodied by an Agilent 1200 Series Diode Array Detector, provided by the applicant Agilent Technologies, and as described in the aforementioned documents “Agilent 1200 Series Diode Array and Multiple Wavelength Detectors User Manual”. It is clear, however, that instead of a photo diode array 720 any other type of detector can be used accordingly. Also, rather than a grating as indicated as diffracting element 710, a prism etc. can be used accordingly.

In contrast to the photo detector 120 as used in the examples of FIGS. 5 and 6, the receiver 120 in FIG. 7 allows detecting different spectral components simultaneously, so that multiplexing and/or modulating might not be required at all or might be used optionally. The spectral flexibility of the light source allows spectral components not needed to be switched off improving the spectral quality of the chromatographic signal to that of a double monochromator.

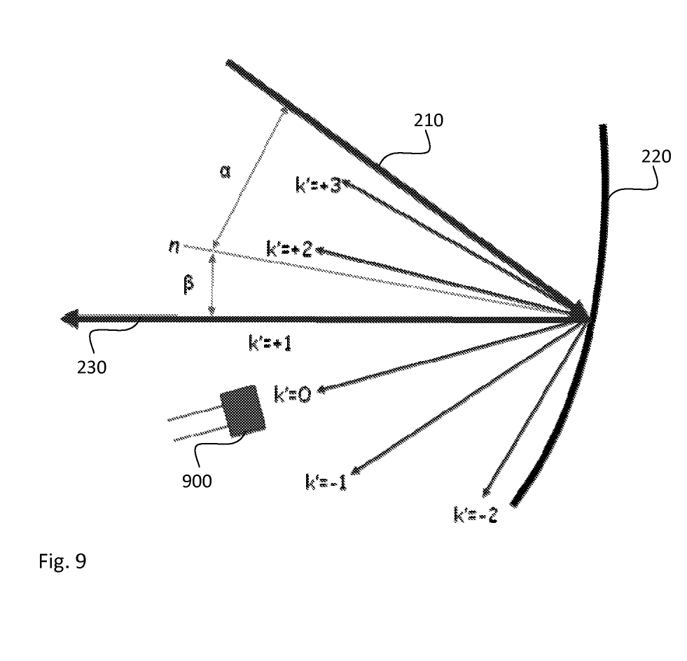

FIG. 8 shows an embodiment of the detector 50, wherein the light source 100 is used also for receiving the response signal. In this embodiment the light source 100 comprises not only a plurality of light emitting elements 200, but also a plurality of light receiving elements 800, each adapted for receiving and sensing a portion of the response signal split up by the diffracting element 220 in accordance with the wavelength of such component. As in FIG. 3, the output light beam is subjected into flow cell 110. However, instead of the receiver 120 located at the opposing side of the flow cell 110, a returning element 810 is provided returning the “response signal” (i.e. the signal exiting the flow cell 110 on the right hand side in FIG. 8) back towards the light source 100. The returning element 810 can be any kind of element allowing to redirect the response signal, such as a mirror, a dihedral element (as indicated in FIG. 8), a turn-mirror arrangement, etc. The response signal might by spatially offset (as indicated by the dihedral element in FIG. 8) with respect to the output beam 230. Alternatively or in combination, the response signal might also be directed again through the sample fluid in the flow cell 110 (so that the stimulus signal travels twice through the flow cell 110, thus leading to an increased absorption path length through the fluid) or guided in a different path (“around” the flow cell 110).

The response signal 700 is then received at the light source 100 and fed back towards the diffracting element 220 splitting up the spectral components dependent on their wavelengths traveling to the light receiving elements 800 (such as a photodiode array). Such a configuration is preferably used in single wavelength mode (cw) or in time or frequency or code multiplexing mode as a multi-wavelength detector. By shifting the response signal 700 with respect to the stimulus signal 230, the receiving elements 800 can be spatially separated from the light emitting elements 200, so that the signal 700 returning from the reflecting element 110 travels in a different path spatially offset from the signal path towards the reflecting element 110.

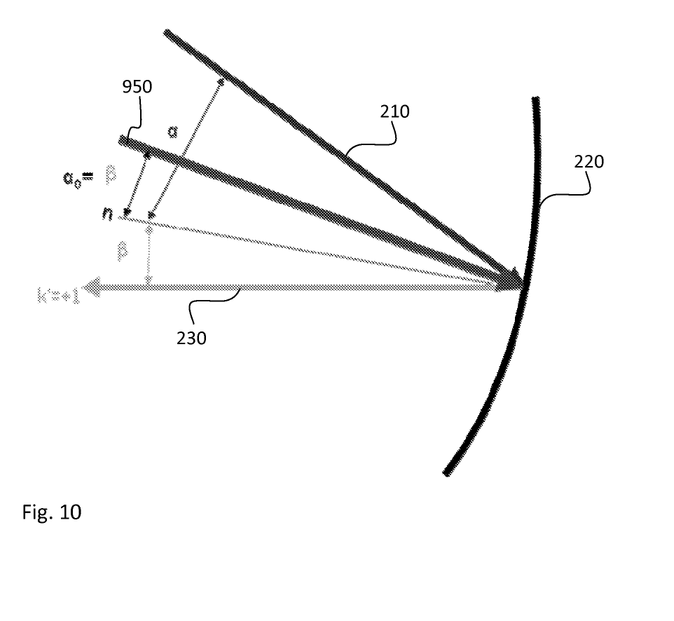

FIG. 9 shows an embodiment, wherein the control unit 70 (see FIG. 1) uses at least one beam from the diffracting element 220 for controlling operation of the light source 100. Such beam might be either diffracted (i.e. the beams of order k′>=1 or k′<=−1, as indicated in FIG. 9) or reflected (i.e. the beam of zero order as the beam with k′=0 as indicated in FIG. 9) from the diffracting element 220. Line n indicates the normal on the grating 220 at the point where the beam 210 hits the grating 220, with angle·being the angle of the impinging beam 210, and angle·being the angle of the output beam 230, both with respect the normal n.

In the embodiment of FIG. 9, the beam of zero order is used for monitoring the output beam 230, in particular with respect to its spectral and intensity profile as well as optical power (intensity) output stability. This is indicated in FIG. 9 by a receiving element, such as a photodetector 900. The output beam 230 can thus be monitored without being influenced.

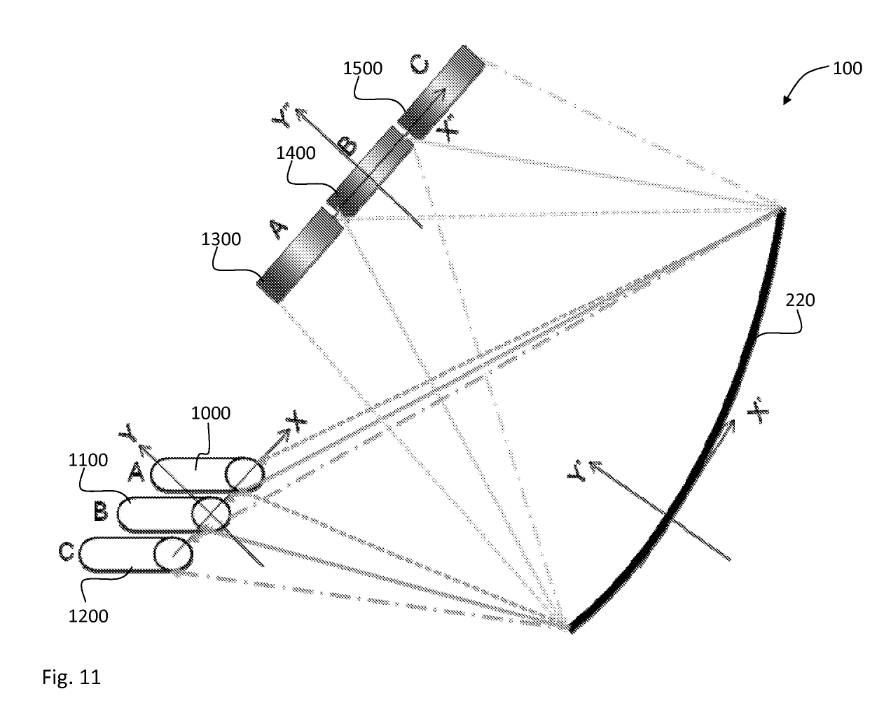

FIG. 10 shows an embodiment, wherein an input beam 950 is used for coupling light into the output beam 230. The input beam 950 represents such beam, which is reflected by the diffracting element 220 “into the output beam 230” as zero order. In the example of FIG. 10, the input beam 950 is impinging the grating 220 in an angle |·₀|=|·| with respect to the normal n, with the angle·being the angle of the output beam 230 with respect the normal n. As the angle of reflection at the diffracting element 220 is independent on the wavelength, this allows to couple in any kind of wavelength component(s), such as monochromatic or polychromatic wavelength spectra, certain light sources (e.g. such as light from a conventional deuterium lamp), etc. into the output beam 230.

The diffracting element 220 is preferably embodied by a grating, which might be a plane or spherical grating. However, other diffracting elements such as a prism can be applied accordingly. Details on gratings can be see, e.g., in the Optics Tutorial “Diffraction Gratings Ruled & Holographic” under http://www.jobinyvon.com/SiteResources/Data/Templates/1divisional.asp?DocID.616& v1ID=&lang.

It has been shown that the light source 100 combining different spectral components by using the diffracting element 220 exhibits certain advantages over light sources using fiber coupling for combining different spectral components. In particular, the light spot area of the output light beam 230 can be significantly reduced over such fiber couplings, in particular as more different wavelengths components are to be combined.

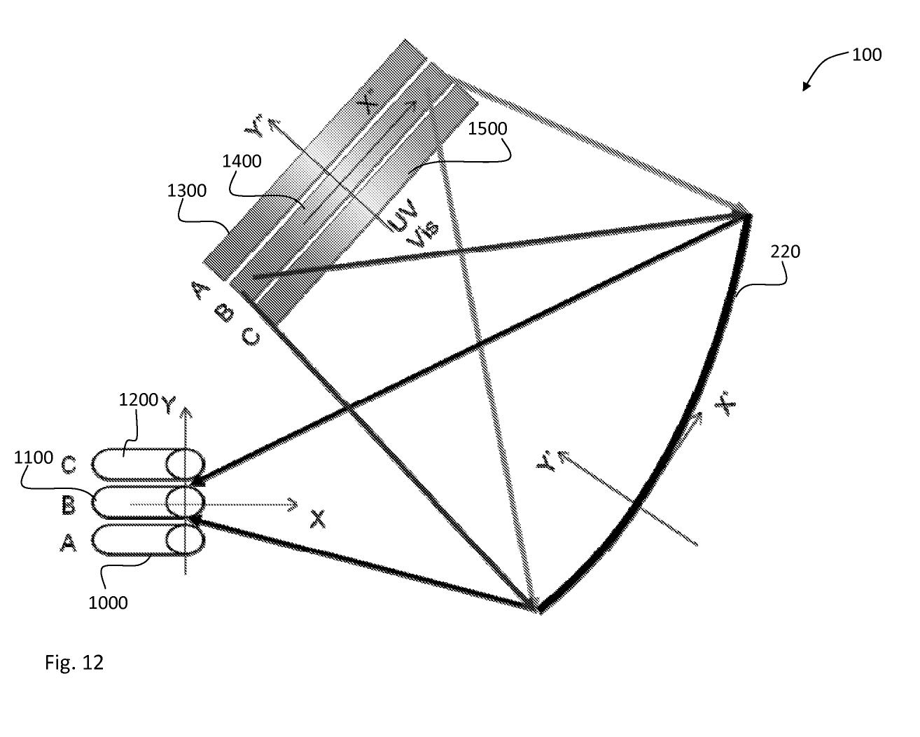

FIG. 11 illustrates another embodiment, wherein the light source 100 provides plural output light beams. In the example of FIG. 11, the light source 100 shall have three outputs 1000, 1100, and 1200, each receiving a respective output light beam from a respective array of light emitting elements 1300, 1400, and 1500. Each array of light emitting elements 1300, 1400, and 1500 can be embodied as described above for the plurality of light emitting elements 200. As indicated by the respective outer light beams (as impinging on the diffracting element 220), each array 1300, 1400, and 1500 is arranged with respect to the diffracting element 220 so that their respective output light beams hits the corresponding one of the outputs 1000, 1100, and 1200, which in this embodiment shall be optical fibers but may also be flow cells, as used in HPLC detection (e.g. absorption or fluorescence detection), etc. Each pair of corresponding array and output is denoted by a respective letter A, B, C, indicating for example that array 1300 has output 1000.

In FIG. 11, a coordinate system XY illustrates the arrangement of the outputs 1000, 1100, and 1200, a coordinate system X′Y′ illustrates the arrangement of the diffracting element 220, and a coordinate system X″Y″ illustrates the arrangement of the array of light emitting elements 1300, 1400, and 1500. As apparent from FIG. 11, the outputs 1000, 1100, and 1200 are arranged along the X-axis, and the array of light emitting elements 1300, 1400, and 1500 are arranged along the X″-axis.

As explained in the foregoing, a spatial offset of an individual light emitting element 200i having a certain (central) wavelength·ᵢ will also lead to a spatial offset of the corresponding output light beam 230. Accordingly, the arrays 1300, 1400, and 1500 can be embodied to be essentially the same or have essentially the same spatial arrangement of light emitting elements, and as result of their spatial offset in direction of X″, their outputs will also be spatially offset along axis X. Preferably, the arrays 1300, 1400, and 1500 are all selected to be identical, so that the light source 100 provides three substantially identical outputs 1000-1200, which can then be used e.g. for parallel processing such as in parallel LC application (wherein plural liquid chromatography processes are executed in parallel).

FIG. 12 shows another embodiment of the light source 100 providing plural output light beams. As FIG. 11, the coordinate system XY illustrates the arrangement of the outputs 1000, 1100, and 1200, the coordinate system X′Y′ illustrates the arrangement of the diffracting element 220, and the coordinate system X″Y″ illustrates the arrangement of the array of light emitting elements 1300, 1400, and 1500. While the arrays 1300-1500 in the embodiment of FIG. 11 are arranged distributed along the X″-axis, the arrays 1300-1500 in the embodiment of FIG. 12 are arranged distributed along the Y″-axis. Accordingly, the corresponding outputs 1000-1200 in FIG. 12 are then distributed along the Y-axis, while the outputs 1000-1200 in FIG. 11 are distributed along the X-axis. As in the exemplary embodiment of FIG. 11, the arrays 1300, 1400, and 1500 in FIG. 12 are preferably selected to be identical, so that the light source 100 provides three substantially identical outputs 1000-1200.

1. A fluid separation system, for separating compounds of a sample fluid in a mobile phase, with a detector adapted to detect separated compounds by providing an optical stimulus signal to the sample fluid and receiving a response signal on the optical stimulus signal, wherein the detector comprises a light source adapted to provide an output light beam as the optical stimulus signal, the light source comprising
a plurality of light emitting elements each adapted to emit a light beam having a respective wavelength, and
a diffracting element,
wherein the plurality of light emitting elements are arranged that emitted light beams impinging on the diffracting element in a respective angle dependent on the respective wavelength are diffracted by the diffracting element into the output light beam.

2. The fluid separation system of claim 1, further comprising a control unit coupled to the light source and being adapted to control operation of at least one of: the light source and one or more of the light emitting elements.

3. The fluid separation system of claim 2, wherein the control unit is adapted to control a number of the light emitting elements concurrently emitting light beams.

4. The fluid separation system of claim 3, wherein the control unit comprises a switching unit adapted for selectively switching on or off one or more of the light emitting elements, thus controlling the number of the light emitting elements concurrently emitting light beams.

5. The fluid separation system of claim 2, wherein the control unit is adapted to control the respective wavelength of one or more of the light emitting elements.

6. The fluid separation system of claim 2, wherein the control unit is adapted to control at least one of modulation and multiplexing of one or more of the emitted light beams.

7. The fluid separation system of claim 6, wherein the control unit is adapted to provide at least one of time multiplexing, frequency multiplexing, code multiplexing, amplitude modulating, and frequency modulating of one or more of the emitted light beams.

8. The fluid separation system of claim 2, wherein the control unit is adapted to control intensity of at least one of the emitted light beams.

9. The fluid separation system of the claim 8, wherein the control unit is adapted to equalize intensities of one or more of the emitted light beams.

10. The fluid separation system of claim 1, wherein the detector further comprises at least one of:
a receiver for receiving the response signal;
a conversion unit for converting the response signal into an electrical response signal;
a signal evaluation unit adapted for evaluating the response signal, in particular to separate and evaluate signal components in the response signal.

11. The fluid separation system of claim 1, wherein the detector further comprises:
a filter for filtering the response signal.

12. The fluid separation system of claim 11, wherein the filter comprising at least one of:
the filter is locked in wavelength on one or more wavelengths of one or more of the emitted light beams;
a demodulator adapted to demodulate the response signal;
a demultiplexer adapted to demultiplex the response signal;
the filter is located in a signal path, from the light source to a receiver for receiving the response signal, before the receiver, preferably for wavelength-filtering the response signal;
the filter is located in a signal path, from the light source to a receiver for receiving the response signal, after the receiver.

13. The fluid separation system of claim 1, wherein one or more of the light emitting elements comprise at least one of:
a light emitting diode;
an organic light emitting diode;
an array of light emitting diodes;
a plasma-source, preferably a micro-plasma;
a laser diode;
a discharge lamp, preferably a micro discharge lamp.

14. The fluid separation system of claim 1, wherein the diffracting element comprises at least one of:
a diffraction grating;
a spherical diffraction grating having a focusing property resulting from the spherical shape;
a plain diffraction grating;
one or more lenses for focusing and/or defocusing beams;
one or more mirrors for redirecting beam;
a prism.

15. The fluid separation system of claim 1, wherein
the light source further is adapted to receive the response signal,
the diffracting element diffracts the received response beam in an angle dependent on the wavelength of one or more wavelength components of the received response beam, and
the plurality of light emitting elements are adapted to sense at least a portion of the diffracted wavelength components.

16. The fluid separation system of claim 1, comprising at least one of:
the control unit uses at least one beam diffracted or reflected from the diffracting element for controlling operation of the light source;
a beam impinging onto the diffraction element is used for coupling light into the output beam as zero order;
one or more of the light emitting elements are adapted to emit a light beam having a respective wavelength in a range between deep UV and infrared.

17. The fluid separation system of claim 1, further comprising at least one of:
a mobile phase drive, preferably a pumping system, adapted to drive the mobile phase through the fluid separations system;
a sample injector adapted to introduce the sample fluid into the mobile phase;
a separation unit, preferably a chromatographic column, adapted for separating compounds of the sample fluid in the mobile phase;
a collection unit adapted to collect separated compounds of the sample fluid;
a data processing unit adapted to process data received from the fluid separation system;
a flow cell adapted for guiding at least a portion of the stimulus signal through the mobile phase.

18. A method in a fluid separation system for separating compounds of a sample fluid in a mobile phase,
emitting one or more light beams, each having a respective wavelength,
diffracting each emitted light beam into an output light beam.
deriving an optical stimulus signal from the output light beam,
providing the optical stimulus signal to the sample fluid,
receiving a response signal on the optical stimulus signal, and
analyzing the response signal to detect separated compounds.

19. A light source comprising
a plurality of light emitting elements each adapted to emit a light beam having a respective wavelength, and
a control unit adapted to control at least one property of each emitted light beam, and
a diffracting element,
wherein the plurality of light emitting elements are arranged that emitted light beams impinging on the diffracting element in a respective angle dependent on the respective wavelength are diffracted by the diffracting element into an output light beam.

20. The light source of claim 19, wherein the property is at least one of amplitude, wavelength, intensity, on-time.

21. The light source of claim 19, wherein the control unit is adapted to provide at least one of time multiplexing, frequency multiplexing, code multiplexing, amplitude modulating, and frequency modulating of one or more of the emitted light beams.
